(19) United States
(12) Patent Application Publication
(10) Pub. No.: US 2015/0186184 A1
(43) Pub. Date: Jul. 2, 2015

(54) APPARATUS AND METHOD FOR OPTIMIZING SYSTEM PERFORMANCE OF MULTI-CORE SYSTEM

(71) Applicant: Electronics and Telecommunications Research Institute, Daejeon (KR)

(72) Inventor: Sang-Pil KIM, Daejeon (KR)

(21) Appl. No.: 14/552,718

(22) Filed: Nov. 25, 2014

(30) Foreign Application Priority Data
Dec. 26, 2013 (KR) 10-2013-0163524

(51) Int. Cl. G06F 9/48

(52) U.S. Cl. CPC G06F 9/4881; G06F 9/4893

(57) ABSTRACT

An apparatus and a method for optimizing a system performance of a multi-core system capable of generally improving a system performance by monitoring a performance of a multi-core assigned to a multi-thread in real-time and by dynamically changing a core already assigned to and used for a thread into another better core through real-time thread switching are disclosed. In the method for optimizing a system performance of a multi-core system, it is analyzed whether or not states of cores assigned to each thread are appropriate based on a performance of a new thread, optimal core assignment information is generated based on the performance of the new thread in order for the states of the cores assigned to each thread to have optimal core assignment when the states of the cores assigned to each thread are inappropriate, and thread switching is performed based on the optimal core assignment information.

### CROSS REFERENCE TO RELATED APPLICATION

This application claims the benefit of Korean Patent Application No. 10-2013-0163524, filed on Dec. 26, 2013, which is hereby incorporated by reference in its entirety into this application.

### BACKGROUND OF THE INVENTION

1. Technical Field

The present invention relates to an apparatus and a method for optimizing a system performance of a multi-core system, and more particularly, to an apparatus and a method for optimizing a system performance of a multi-core system configured of a plurality of cores having various performance levels.

2. Description of the Related Art

Due to a limitation in additional performance improvement and low power implementation in a single core based system, a core system structure has been changed from the single core based system into a multi-core system, and the multi-core system will be mainly used in the future.

It is important in a multi-core system environment how a system performance may be improved and how much power consumption may be decreased.

A simple method for improving the system performance is to use a better core, and a method for decreasing the power consumption is to use a system designed at a low power. However, since these are already determined when a hardware system is configured, there is no room for further improvement.

In a general method of assigning cores in the multi-core system environment configured of a plurality of cores having different performances as described above, information on a core to be assigned to a newly generated thread is transferred to a core binder 14 based on information of a core performance information database (DB) 10 by a scheduler 12, as shown in FIG. 1. The core binder 14 allocates a thread to a corresponding core depending on core assigning information determined by the scheduler 12.

In this method, the core is assigned to the thread at a point in time at which the thread is generated and is not changed until the thread ends. In this case, although the best selection may be made when the core is assigned to the generated threads, an optimal assignment may not be made in a system environment in which a plurality of threads are allocated to and are performed in a plurality of cores. The reason is that information on a later generated thread may not be recognized.

In other words, in a core assigning method according to the related art, as shown in FIG. 1, when the thread is generated, an appropriate core among usable cores as many as possible is allocated depending on the information of the core performance information DB 10 to improve a system performance or a core satisfying an initial condition minimizing power consumption is assigned. In this method, which is a method of assigning an optimal core among the usable cores in consideration of a performance required in the thread only when the core is assigned, a static assigning method is used.

In assigning the core to the thread, the static assigning method has a limitation in using the system performance in an optimal state. The reason is that it is impossible in principle to efficiently distribute resources of the system since the core should be assigned to the thread in a state in which a generation sequence of threads to be performed is unpredictable.

In the method for statically assigning the core to the thread according to the related art, even though an optimal selection is made in an assigning instant, it is likely that the selection will not be optimal in an entire system environment in which a plurality of threads are simultaneously performed. In addition, since it is difficult to recognize information on a performance required by the generated thread in advance, the core can not but be appropriately assigned depending on a type of the thread.

As the related art, a content for accomplishing load distribution without a substantial overhead by changing core allocation of the thread rather than changing data distribution has been disclosed in Korean Patent Laid-Open Publication No. 2010-0074920 entitled “Apparatus and Method for Load Balancing in Multi-core System”.

In Korean Patent Laid-Open Publication No. 2010-0074920, it is determined whether or not a load of a multi-core to each of which a plurality of threads are allocated, is unbalanced, and load balancing is performed by changing core allocation of at least one of the plurality of threads for the multi-core in the case in which it is determined that the load is unbalanced.

As another related art, a content for decreasing a power consumption amount of a chip multi-processor while maintaining a performance thereof and decreasing an area of a process to easily manufacture the processor has been disclosed in Korean Patent Laid-Open Publication No. 2008-0076392 entitled ““Extended Processor for Executing Multi-threads in Embedded Core and Method for Executing Multi-threads in Embedded Core”.

In Korean Patent Laid-Open Publication No. 2008-0076392, when threads are generated in a multi-core environment, some of the threads are generated as threads with which communication modules are combined, and a server performs a corresponding work.

### SUMMARY OF THE INVENTION

Accordingly, the present invention has been made keeping in mind the above problems occurring in the conventional art, and an object of the present invention is to provide an apparatus and a method for optimizing a system performance of a multi-core system capable of generally improving a system performance or using low power by monitoring a performance of a multi-core assigned to a multi-thread in real-time in the multi-core system configured of cores having various performance levels to dynamically changing a core already assigned to and used for a thread into another better core through real-time thread switching.

In accordance with an aspect of the present invention, there is provided a method for optimizing a system performance of a multi-core system, including: analyzing, by a real-time performance analyzer, whether or not states of cores assigned to each thread are appropriate based on a performance of a new thread when the new thread is generated; generating, by the real-time performance analyzer, optimal core assignment information based on the performance of the new thread in order for the states of the cores assigned to each thread to have optimal core assignment when it is determined that the states of the cores assigned to each thread are inappropriate; and performing, by a thread switching scheduler, thread switching based on the optimal core assignment information.

The performance of the new thread may include a required performance group and a required performance value of the corresponding new thread.

The states of the cores assigned to each thread may include relative performance values of the cores assigned to each thread.

The method for optimizing a system performance of a multi-core system may further include, after the performing of the thread switching, updating, by the real-time performance analyzer, information of a core assignment information database based on the optimal core assignment information.

The method for optimizing a system performance of a multi-core system may further include, after the performing of the thread switching, updating, by the thread switching scheduler, information of a core assignment information database based on the optimal core assignment information.

In accordance with another aspect of the present invention, there is provided an apparatus for optimizing a system performance of a multi-core system, including: a real-time performance analyzer analyzing whether or not states of cores assigned to each thread are appropriate based on a performance of a new thread when the new thread is generated and generating optimal core assignment information based on the performance of the new thread in order for the states of the cores assigned to each thread to have optimal core assignment when it is determined that the states of the cores assigned to each thread are inappropriate; and a thread switching scheduler performing thread switching based on the optimal core assignment information.

The apparatus for optimizing a system performance of a multi-core system may further include a core assignment information database storing the core assignment information therein.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram for describing a general method for assigning a core to a thread in a multi-core environment;

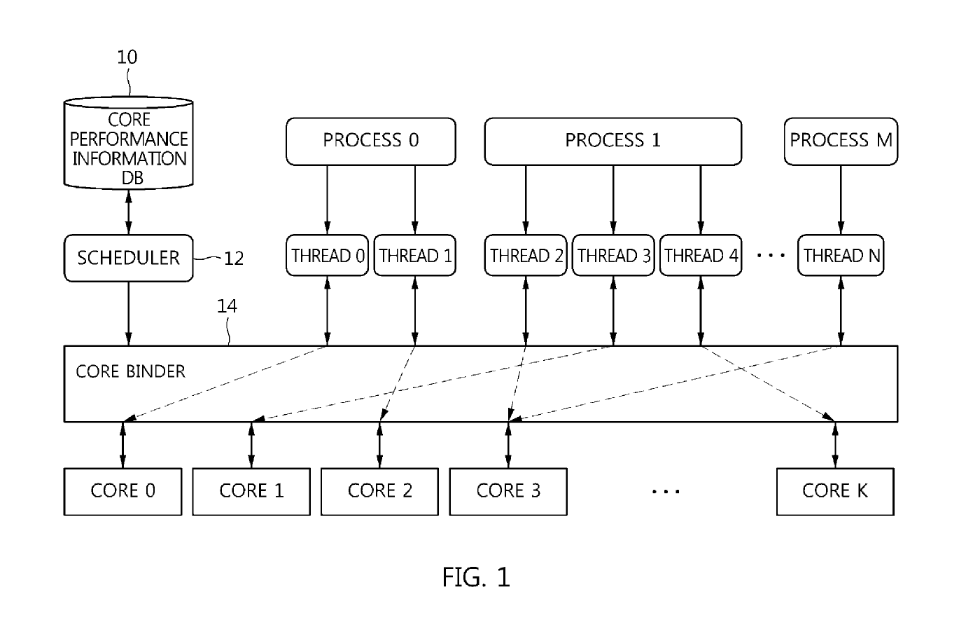

FIG. 2 is a configuration diagram of an apparatus for optimizing a system performance of a multi-core system according to an embodiment of the present invention; and

FIG. 3 is a flow chart for describing a method for optimizing a system performance of a multi-core system according to an embodiment of the present invention.

### DESCRIPTION OF THE PREFERRED EMBODIMENTS

The present invention may be variously modified and have several embodiments. Therefore, specific embodiments of the present invention will be illustrated in the accompanying drawings and be described in detail.

However, it is to be understood that the present invention is not limited to specific embodiments, but includes all modifications, equivalents, and substitutions without departing from the scope and spirit of the present invention.

Terms used in the present specification are used only in order to describe specific embodiments rather than limiting the present invention. Singular forms are intended to include plural forms unless being clearly indicated otherwise in the context. It is to be understood that terms “include” or “have” used in the present specification, specify presence of stated features, numerals, steps, operations, components, parts, or a combination thereof, but do not preclude presence or addition of one or more other features, numerals, steps, operations, components, parts, or a combination thereof.

Unless being defined otherwise, it is to be understood that all the terms used in the present specification including technical and scientific terms have the same meanings as those that are generally understood by those skilled in the art. Terms generally used and defined by a dictionary should be interpreted as having the same meanings as meanings within a context of the related art and should not be interpreted as having ideal or excessively formal meanings unless being clearly defined otherwise in the present specification.

Hereinafter, embodiments of the present invention will be described in more detail with reference to the accompanying drawings. In order to facilitate the entire understanding of the present invention in describing the present invention, the same components will be denoted by the same reference numerals throughout the accompanying drawings, and an overlapped description for the same components will be omitted.

The present invention is to monitor a core assigned to a thread in real-time and change the core through dynamic thread switching in order to optimize a performance in a multi-core environment (cores having several performance levels).

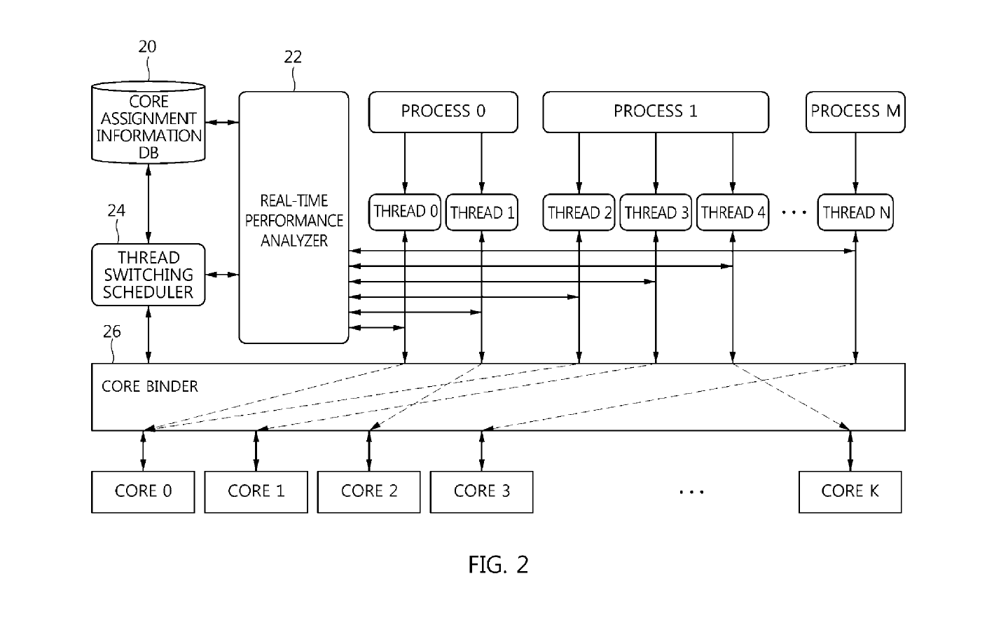

FIG. 2 is a configuration diagram of an apparatus for optimizing a system performance of a multi-core system according to an embodiment of the present invention.

The apparatus for optimizing a system performance of a multi-core system according to an embodiment of the present invention is configured to include a core assignment information database (DB) 20, a real-time performance analyzer 22, a thread switching scheduler 24, and a core binder 26.

The core assignment information DB 20 stores information on cores assigned to each thread, that is, core assignment information (including performance information having relative performance values of cores) therein. Here, the core assignment information is not static information on the cores assigned in the initial state of generation of the threads and maintained until the thread ends, but may be updated in real-time for each thread.

The real-time performance analyzer 22 analyzes performances of the threads and the cores in real-time to generate optimal core assignment information. The real-time performance analyzer 22 informs the thread switching scheduler 24 of the optimal core assignment information analyzed in real-time.

In other words, the real-time performance analyzer 22 analyzes whether or not states of the cores assigned to each thread are appropriate based on a performance of a new thread when the new thread is generated and generates optimal core assignment information based on the performance of the new thread (including a required performance group and a required performance value of the corresponding new thread) in order for the states of the cores assigned to each thread (including relative performance values of the cores assigned to each thread) to have optimal core assignment when it is determined that the states of the cores assigned to each thread are inappropriate.

In addition, the real-time performance analyzer 22 may update information of the core assignment information DB 20 based on the newly generated optimal core assignment information.

The thread switching scheduler 24 allocates threads generated by a thread module generating unit (not shown) of processes generated by a request of a user or a user interface (not shown) to specific cores. Here, the thread switching scheduler 24 allocates there threads based on the core assignment information from the real-time performance analyzer 22. Particularly, the thread switching scheduler 24 performs thread switching based on the core assignment information provided in real-time by the real-time performance analyzer 22.

The core binder 26 connects the thread to the corresponding core based on the information transferred from the thread switching scheduler 24.

According to an embodiment of the present invention having the above-mentioned configuration, the real-time performance analyzer 22 analyzes the thread performance in real-time and generates the optimal core assignment information when it is analyzed that the state of the core assigned to the thread is not appropriate. Therefore, the thread switching scheduler 24 switches the core assigned to the existing thread into another more appropriate core through a thread switching method based on the optimal core assignment information generated by the real-time performance analyzer 22. In this case, a performance is generally improved or power consumption is decreased, thereby making it possible to improve efficiency of a system.

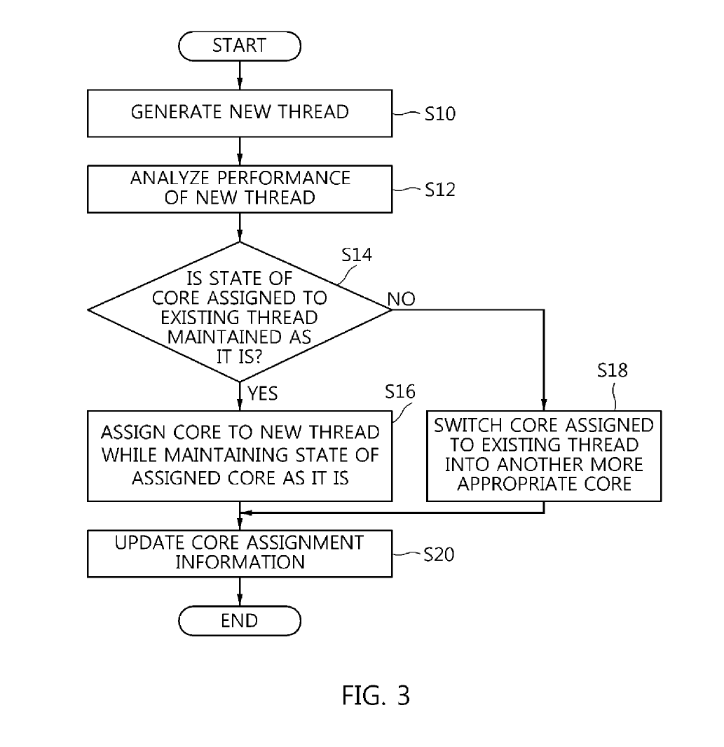

FIG. 3 is a flow chart for describing a method for optimizing a system performance of a multi-core system according to an embodiment of the present invention.

After a core is assigned to an initial thread, when a new thread is generated by a thread module generating unit (not shown) (S10), the real-time performance analyzer 22 analyzes performances of the new thread and the assigned core (S12). Here, the respective threads have their required performance groups and required performance values, and the respective cores have their relative performance values.

In the case in which a state of the core assigned to the existing thread may be maintained as it is (“Yes” in S14) as an analyzing result, the real-time performance analyzer 22 transmits information allowing immediately previous core assignment information to be maintained as it is to the thread switching scheduler 24.

Therefore, the thread switching scheduler 24 allocates the new thread to a specific core while maintaining the immediately previous core assignment information as it is, that is, while maintaining the state of the assigned core as it is (S16).

In the case in which it is analyzed in S14 that the state of the core assigned to the existing thread is not appropriate (“No” in S14), the real-time performance analyzer 22 generates optimal core assignment information based on the performances of the new thread and the assigned core (S16). In addition, the real-time performance analyzer 22 informs the thread switching scheduler 24 of the generated optimal core assignment information. Therefore, the thread switching scheduler 24 switches the core assigned to the existing thread into another more appropriate core based on the newly generated optimal core assignment information (S18).

Then, the real-time performance analyzer 22 updates information of the core assignment information DB 20 based on the newly generated optimal core assignment information (S20).

Although the case in which the real-time performance analyzer 22 updates the information of the core assignment information DB 20 based on the optimal core assignment information has been described above with reference to FIG. 3, the thread switching scheduler 24 may also update the information of the core assignment information DB 20 after the thread switching, if necessary.

This will be again described with reference to a specific example. For example, it is assumed that four cores (Core A, Core B, Core C, and Core D) having different performances are present and four threads (Thread A, Thread B, Thread C, and Thread D) that are generated and performed are also present.

Here, it is assumed that performances (relative performance value) of each core and performance required values of each thread are as follows.

TABLE 1
Relative Performance Value Depending on Core

| | Core | Core | Core | Core | |
|---|---|---|---|---|---|
| | A | B | C | D | Remark |
| Relative | 1.0 | 1.5 | 2.0 | 2.5 | High Performance |
| Performance | | | | | When Numeral is |
| | | | | | Large |

Performance Required Value of Each Thread

| | Thread | Thread | Thread | Thread | |
|---|---|---|---|---|---|
| | A | B | C | D | Remark |
| Required | Medium | Medium | High | Low | High Required |
| Performance | | | | | Performance |
| Group | | | | | Group |
| Required | 20 | 24 | 32 | 15 | D < A < B < C |
| Performance | | | | | |

In the above Table 1, a performance value of the core A is 1.0, a performance value of the core B is 1.5, a performance value of the core C is 2.0, and a performance value of the core D is 2.5. The performance value of the core indicates that performance becomes higher as a numeral value becomes higher. Therefore, performances of the cores are as follows: “Core D>Core C>Core B>Core A”.

In addition, referring to the above Table 1, as threads used in the system, there are the thread C (having a required performance value of 32) belonging to a group requiring a high performance, the thread A (having a required performance value of 20) and the thread B (having a required performance value of 24) belonging to a group requiring a medium performance, and the thread D (having a required performance value of 15) belonging to a group requiring a low performance. Here, in dividing required performance groups of each thread, a thread having a required performance value of 10 to 19 is a thread belonging to a group requiring a low performance, a thread having a required performance value of 20 to 29 is a thread belonging to a group requiring a medium performance, and a thread having a required performance value of 30 to 39 is a thread belonging to a group requiring a high performance.

When the number of generated threads is four as assumed in the above Table 1, in the case in which the cores are statically assigned based on the core performance information, the cores may be generally assigned as shown in the following Table 2 even though they are differently assigned depending on an initial assignment algorithm.

TABLE 2

| | | |
|---|---|---|
| Required Performance | Static Thread | |
| Group of Thread | Assigning Method | Remark |

| | | |
|---|---|---|
| Thread A | Medium (20) | Core C (2.0) |
| Thread B | Medium (24) | Core D (2.5) |
| Thread C | High (32) | Core B (1.5) |
| Thread D | Low (15) | Core A (1.0) |

The reason will be described below.

If a required performance group of the thread A that is first generated is medium, firstly, the cores (that is, the core B (1.5) and the core C (2.0)) having a medium performance among the four cores are chosen; secondly, the core C is assigned to the thread A, because the core C has a performance higher than that of the core B.

Then, when the thread B is generated, since a required performance group of the thread B is medium, but a required performance value of the thread B is higher than that of the thread A, the core D (2.5) having a performance higher than that of the core C assigned to the thread A is assigned to the thread B.

Then, when the thread C is generated, even though the thread C requires a core having a high performance, since the core D having the highest performance is already assigned, the core B having a higher performance in the remaining cores (that is, the core A (1.0) and the core B (1.5) is assigned to the thread C.

A usable core (that is, the core A) is selected and assigned to the thread D that is later generated.

In the static thread assigning method as described above, the cores may not be essentially assigned optimally, and there is a limitation since there is no information on what thread is additionally generated at a core assigning point in time depending on the generation of the thread.

On the other hand, when a dynamic thread assigning method of analyzing thread performing states in real-time and dynamically changing the cores appropriate for the threads through the thread switching according to an embodiment of the present invention is used, the cores may be assigned as shown in the following Table 3.

TABLE 3

| | | |
|---|---|---|
| Required Performance | Dynamic Thread | |
| Group of Thread | Assigning Method | Remark |

| | | |
|---|---|---|
| Thread A | Medium (20) | Core B (1.5) |
| Thread B | Medium (24) | Core C (2.0) |
| Thread C | High (32) | Core D (2.5) |
| Thread D | Low (15) | Core A (1.0) |

That is, in a method for re-assigning the cores to the threads by a dynamic thread switching method, the performances of the threads of the system are analyzed in real-time regardless of how the cores are assigned when the initial thread is generated, and a core having a high performance is re-assigned to a thread requiring a high performance using a dynamic thread switching function when a core having a low performance is assigned to the thread requiring the high performance. In other words, while the cores are allocated to the threads so as not to be appropriate for performances and performance groups required by each thread in the related art, the cores are assigned so as to be appropriate for performances and performance groups required by each thread in an embodiment of the present invention. Therefore, the cores are optimally assigned over time regardless of an initial state, thereby making it possible to improve a performance of the system or decrease power consumption.

As described above, in the present invention, the performance of the system is dynamically analyzed during a period in which the cores are assigned to the threads and the threads are performed in the multi-core environment using a multi-thread to re-assign the cores assigned to the threads through the thread switching so as to be appropriate for the performances of the threads, thereby making it possible to optimize the performance of the system.

In accordance with the present invention having the above-mentioned configuration, when the cores are assigned to the threads in the multi-core system using the multi-thread, the performances of the threads that are being used in real-time after the core is assigned to the initial thread are analyzed and the optimal cores are re-assigned to the threads using the thread switching method to optimize the performance of the system, thereby making it possible to improve the performance of the system or decrease the power consumption.

Hereinabove, embodiments of the present invention have been disclosed in the accompanying drawings and the specification. In the present specification, although specific terms have been used, they are used only in order to describe the present invention and are not used in order to limit the meaning or the scope of the present invention, which is disclosed in the appended claims. Therefore, it is to be understood by those skilled in the art that various modifications are made and other equivalent embodiments are possible. Accordingly, an actual technical scope of the present invention is to be determined by the spirit of the appended claims.

What is claimed is:

1. A method for optimizing a system performance of a multi-core system, comprising:
analyzing, by a real-time performance analyzer, whether or not states of cores assigned to each thread are appropriate based on a performance of a new thread when the new thread is generated;
generating, by the real-time performance analyzer, optimal core assignment information based on the performance of the new thread in order for the states of the cores assigned to each thread to have optimal core assignment when it is determined that the states of the cores assigned to each thread are inappropriate; and
performing, by a thread switching scheduler, thread switching based on the optimal core assignment information.

2. The method for optimizing a system performance of a multi-core system of claim 1, wherein the performance of the new thread includes a required performance group and a required performance value of the corresponding new thread.

3. The method for optimizing a system performance of a multi-core system of claim 1, wherein the states of the cores assigned to each thread include relative performance values of the cores assigned to each thread.

4. The method for optimizing a system performance of a multi-core system of claim 1, further comprising, after the performing of the thread switching, updating, by the real-time performance analyzer, information of a core assignment information database based on the optimal core assignment information.

5. The method for optimizing a system performance of a multi-core system of claim 1, further comprising, after the performing of the thread switching, updating, by the thread switching scheduler, information of a core assignment information database based on the optimal core assignment information.

6. An apparatus for optimizing a system performance of a multi-core system, comprising:
a real-time performance analyzer analyzing whether or not states of cores assigned to each thread are appropriate based on a performance of a new thread when the new thread is generated and generating optimal core assignment information based on the performance of the new thread in order for the states of the cores assigned to each thread to have optimal core assignment when it is determined that the states of the cores assigned to each thread are inappropriate; and
a thread switching scheduler performing thread switching based on the optimal core assignment information.

7. The apparatus for optimizing a system performance of a multi-core system of claim 6, wherein the performance of the new thread includes a required performance group and a required performance value of the corresponding new thread.

8. The apparatus for optimizing a system performance of a multi-core system of claim 6, wherein the states of the cores assigned to each thread include relative performance values of the cores assigned to each thread.

9. The apparatus for optimizing a system performance of a multi-core system of claim 6, further comprising a core assignment information database storing the core assignment information therein.

10. The apparatus for optimizing a system performance of a multi-core system of claim 9, wherein the real-time performance analyzer updates information of the core assignment information database based on the optimal core assignment information when the thread switching in the thread switching scheduler is completed.

11. The apparatus for optimizing a system performance of a multi-core system of claim 9, wherein the thread switching scheduler updates information of the core assignment information database based on the optimal core assignment information when the thread switching is completed.
